(19) United States
(12) Patent Application Publication
(10) Pub. No.: US 2025/0371149 A1
(43) Pub. Date: Dec. 4, 2025

(54) METHOD FOR DETECTING ATTACK FOR VEHICLE AND RELATED DEVICE

(71) Applicants: HUAWEI TECHNOLOGIES CO., LTD., Shenzhen (CN); Hong Kong University of Science & Technology, Hong Kong (CN)

(72) Inventors: Girish REVADIGAR, Shenzhen (CN); Tianci Yang, Singapore (SG); Nachuan Yang, Hong Kong (CN); Yamin Yan, Hong Kong (CN); Ling Shi, Hong Kong (CN)

(73) Assignees: HUAWEI TECHNOLOGIES CO., LTD., Shenzhen (CN); Hong Kong University of Science & Technology, Hong Kong (CN)

(21) Appl. No.: 19/298,542

(22) Filed: Aug. 13, 2025

Related U.S. Application Data
(63) Continuation of application No. PCT/CN2023/076007, filed on Feb. 14, 2023.

(51) Int. Cl. G06F 21/56

(52) U.S. Cl. CPC G06F 21/56; G06F 2221/034

(57) ABSTRACT

A method for detecting an attack for a vehicle and a related device includes: determining a first prediction data according to a first correction data and a first control data, where the first correction data is a correction data of at least one sensor in the vehicle at a moment k−1, where the first control data includes at least one control command of the vehicle at the moment k−1, where the first prediction data is a prediction data of the at least one sensor at a moment k; obtaining a first observation data by the at least one sensor at the moment k; and determining whether the vehicle is under an attack according to the first observation data and the first prediction data. The first predication data is determined according to previous sensor data of the vehicle.

### STATEMENT OF JOINT RESEARCH AGREEMENT

The subject matter and the claimed invention were made by or on the behalf of Huawei Technologies Co., Ltd., of Shenzhen, Guangdong Province, P.R. China, and Hong Kong University of Science & Technology, of Hong Kong, P.R. China, under a joint research agreement titled “Attack Resilient Control Systems for Cyber Physical Systems Project”. The joint research agreement was in effect on or before the claimed invention was made, and that the claimed invention was made as a result of activities undertaken within the scope of the joint research agreement.

### CROSS-REFERENCE TO RELATED APPLICATIONS

This application is a continuation of International Application No. PCT/CN2023/076007, filed on Feb. 14, 2023, the disclosure of which is hereby incorporated by reference in its entirety.

### TECHNICAL FIELD

Embodiments of the present invention relate to the field of vehicle technologies, and more specifically, to a method for detecting an attack for a vehicle and a related device.

### BACKGROUND

Unlike traditional vehicles where software and hardware play a supporting role (e.g., controlling in-vehicle infotainment (IVI) and monitoring the vehicle's operation), software and hardware in modern vehicles can control the vehicle's actuators, which control acceleration, braking, steering or the like. Therefore, the modern vehicles can navigate without human intervention. More hardware and more sophisticated software may increase risks of a malicious attack. Attackers may install modified software (malware) on electronic devices in the vehicles to gain access to the vehicles and/or steal sensitive information. Malicious software may enter the vehicle's internal network and reprogram the electronic devices in the vehicles. Since the actuators of the vehicles can be controlled by hardware and software, the malicious attack on the modern vehicles may lead to more serious consequences. Therefore, how to detect a malicious attack on vehicles is a problem that needs to be addressed.

### SUMMARY

Embodiments of the present application provide a method for detecting an attack for a vehicle and a related device. According to the technical solution, the vehicle may detect a malicious attack according to sensor data of the vehicle.

According to a first aspect, an embodiment of the present application provides a method for detecting an attack for a vehicle, where the method including: determining a first prediction data according to a first correction data and a first control data, where the first correction data is a correction data of at least one sensor in the vehicle at a moment k−1, the first control data includes at least one control command of the vehicle at the moment k−1, the first prediction data is a prediction data of the at least one sensor at a moment k, and k is a positive integer; obtaining a first observation data by the at least one sensor at the moment k; and determining whether the vehicle is under an attack according to the first observation data and the first prediction data.

The first predication data is determined according to previous sensor data of the vehicle. If a vehicle is not under attack, the first prediction data and the first observation data may be the same or the difference between the first prediction data and the first observation data may be minor. According to the above-mentioned solution, the vehicle may determine whether the vehicle is under attack according to data obtained from the sensor in the vehicle. In other words, the vehicle may determine on its own whether the vehicle is under attack without relying on data from other vehicles.

In a possible design, the first prediction data is determined based on a Kalman filter.

In a possible design, the Kalman filter may be a classic Kalman filter, an extended Kalman filter, or an adaptive Kalman filter.

The Kalman filter can use a series of measurements to produce estimates of unknown variables. Compared with other estimate algorithms, the Kalman filter can produce a more accurate estimation.

In a possible design, where the first predication data satisfies a following formula: x(k|k−1)=Ax(k−1|k−1)+Bu(k−1), where x(k|k−1) is the first prediction data, x(k−1|k−1) is the first correction data, u(k−1) is the first control data, and A and B are preset matrices.

In a possible design, the method further includes: determining a second correction data according to the first prediction data and the first observation data based on the Kalman filter.

The second correction data may be used for determine whether the vehicle is under attack at the moment k+1.

In a possible design, the second correction data satisfies a following formula: x(k|k)=x(k|k−1)+K[y(k)-Cx(k|k−1)], where x(k|k) is the second correction data, x(k|k−1) is the first prediction data, y(k) is the first observation data, and K and C are preset matrices.

In a possible design, y(k)-Cx(k |k−1) is zero-mean white Gaussian distributed with covariance CPC′+R, where P is covariance of prediction error, and Ris covariance of measurement noise.

In a possible design, the determining whether the vehicle is under attack according to the first observation data and the first prediction data includes: determining an evaluation parameter based on the observation data and the first prediction data according to the following formula:

$${E}_{k} = {\sum }_{i = k - T + 1}^{k} {{[ y ( i ) - Cx ( i \vert i - 1 ) ]}^{′} [ {CPC}^{′} + R ]}^{- 1} [ y ( i ) - Cx ( i \vert i - 1 ) ] ,$$

where Eₖ is the evaluation parameter, T is a window size for detection, y(i) is an observation data obtained by the at least one sensor in moment i, and x(i|i-1) is a prediction data of the at least one sensor at a moment i; determining that the vehicle is not under attack when the evaluation parameter is less than or equals to a preset threshold; and determining that the vehicle is under attack when the evaluation parameter is greater than the preset threshold.

In accordance with the above-mentioned solution, the evaluation parameter is determined according to the prediction data and the observation data during a time period. This solution may avoid abnormal data. For example, if kₓ is a moment during the time period, some accidents may cause abnormal sensor data. If the evaluation parameter is determined in accordance with the sensor data at the moment kₓ, the vehicle may determine that an attack has occurred. However, in accordance with the above-mentioned solution, since kₓ is only one moment during the time period, the abnormal sensor data may not affect a final determination.

According to a second aspect, an embodiment of the present application provides an electronic device, and the electronic device has a function of implementing the method in the first aspect. The function may be implemented by hardware, or may be implemented by hardware executing corresponding software. The hardware of the software includes one or more modules corresponding to the function.

According to a third aspect, an embodiment of the present application provides a computer readable storage medium, including instructions. When the instructions run on a computer, the computer is enabled to perform the method in the first aspect or any possible implementation of the first aspect.

According to a fourth aspect, an electronic device is provided, including a processor and a memory. The processor is connected to the memory. The memory is configured to store instructions, and the processor is configured to execute the instructions. When the processor executes the instructions stored in the memory, the processor is enabled to perform the method in the first aspect or any possible implementation of the first aspect.

According to a fifth aspect, a chip system is provided, where the chip system includes a memory and a processor, and the memory is configured to store a computer program, and the processor is configured to invoke the computer program from the memory and run the computer program, so that a vehicle on which the chip system is disposed performs the method in the first aspect or any possible implementation of the first aspect.

According to a sixth aspect, a computer program product is provided, where when the computer program product runs on an electronic device, the electronic device is enabled to perform the method in the first aspect or any possible implementation of the first aspect.

According to a seventh aspect, a vehicle is provided, where the vehicle includes the electronic device according to any one of the second aspect to the sixth aspect.

### DESCRIPTION OF DRAWINGS

FIG. 1 illustrates a malicious attack towards an on-road vehicle.

FIG. 2 illustrates a flowchart of an embodiment method for detecting an attack for a vehicle.

FIG. 3 illustrates an attack detection procedure in an adaptive cruise control system.

FIG. 4 illustrates a Kalman filter.

FIG. 5 illustrates the above-mentioned attack detection procedure.

FIG. 6 illustrates another attack detection procedure provided by an embodiment of the present application.

FIG. 7 is a schematic block diagram of an electronic device according to an embodiment of the present application.

FIG. 8 is a schematic block diagram of another electronic device according to an embodiment of the present application.

### DESCRIPTION OF EMBODIMENTS

The following describes the technical solutions in the present application with reference to the accompanying drawings.

A modern vehicle mentioned in the present application may also be referred to as a smart vehicle, an autonomous vehicle, a self-driving vehicle or the like. The modern vehicle may include one or more sensors which can monitor environment of the vehicle, and obtain some driving behavior parameters (e.g., average running speed, average acceleration, average deceleration, position information or the like). A modern vehicle's sensor may include a speedometer, an ultrasonic radar, a camera, an inertial measurement unit (IMU) and a global navigation satellite system (GNSS) module, etc. The modern vehicle may be an automobile (such as a car, a truck, a bus or the like), an automated delivery vehicle, an aerial vehicle, a watercraft and so on. For convenience, in the following embodiments, the modern vehicle is referred to as a vehicle.

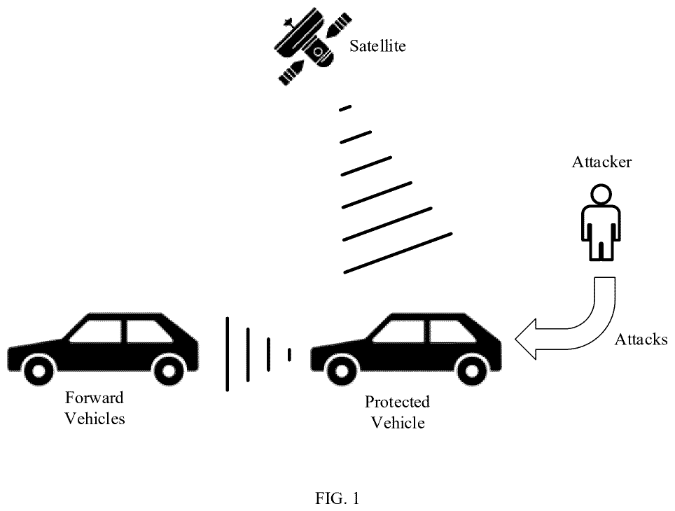

FIG. 1 illustrates a malicious attack towards an on-road vehicle.

As shown in FIG. 1, a protected vehicle uses a sensor (e.g., a camera or an ultrasonic radar) to monitor distance between the protected vehicle and a front vehicle, and uses a GNSS module to acquire speed and position information from a GNSS's satellite. An attacker may cause car crashes by compromising the protected vehicle's sensor.

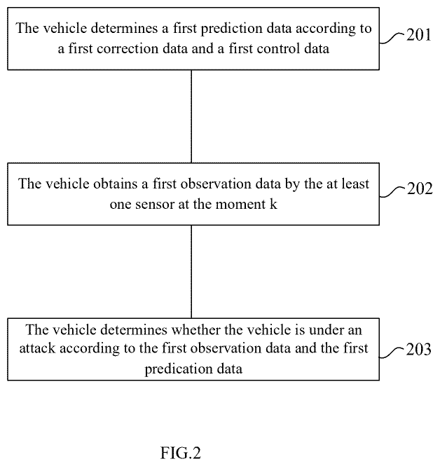

FIG. 2 illustrates a flowchart of an embodiment method for detecting an attack for a vehicle.

In block 201, the vehicle determines a first prediction data according to a first correction data and a first control data.

The first correction data is a correction data of at least one sensor in the vehicle at a moment k−1. For convenience, the first correction data is referred to as x(k−1|k−1), and k is a positive integer.

The first control data includes at least one control command of the vehicle at the moment k−1. For convenience, the first control data is referred to as u(k−1). The control command may include a brake command and a throttle command.

The first prediction data is a prediction data of the at least one sensor at a moment k. For convenience, the first prediction data is referred to as x(k|k−1).

In block 202, the vehicle obtains a first observation data by the at least one sensor at the moment k. For convenience, the first observation data is referred to as y(k).

In block 203, the vehicle determines whether the vehicle is under an attack according to the first observation data and the first predication data.

According to the method shown in FIG. 2, the vehicle may determine whether the vehicle is under an attack according to data obtained from the sensor in the vehicle. In other words, the vehicle may determine on its own whether the vehicle is under an attack without relying on data from other vehicles.

An adaptive cruise control (ACC) system plays an important role in automobile road safety. The ACC is an available cruise control advanced driver-assistance system for road vehicles, which automatically adjusts the vehicle speed to maintain a safe distance from a front vehicle. A vehicle equipped with the ACC system is referred to as an ACC vehicle or an own vehicle. A vehicle before the ACC vehicle is referred to as a front vehicle. There are three main states of the ACC system:
1) ACC Off—A direct access to an “ACC active” state is disabled.
2) ACC Standby—The system is ready for activation by the driver.
3) ACC Active—The system is in active control of the vehicle's speed.
i. ACC Speed Control-No front vehicles are present, then the ACC system is controlling vehicle speed to a “set speed”.
ii. ACC Time Gap Control—A time gap, or headway, between the ACC vehicle and the target vehicle is being controlled.

The target vehicle is one of the front vehicles closest to the ACC vehicle in the path of the ACC vehicle. The time gap is a time interval between the ACC vehicle and the target vehicle.

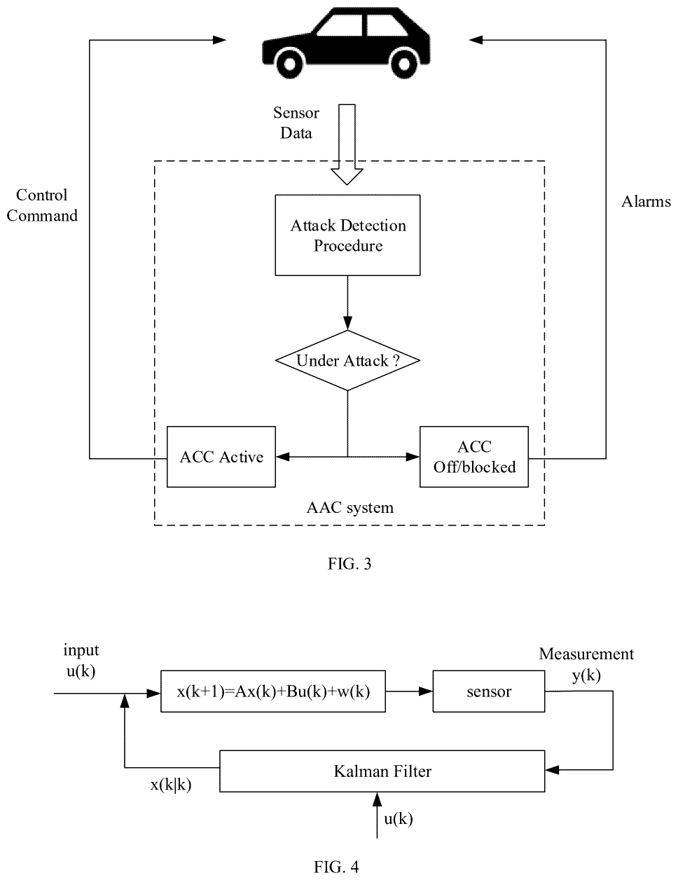

FIG. 3 illustrates an attack detection procedure in an adaptive cruise control system.

The attack detection procedure shown in FIG. 3 is the embodiment method shown in FIG. 2. As shown in FIG. 3, if the vehicle determines that the vehicle is under attack, the vehicle may turn off the ACC mode or block the ACC system; and if the vehicle determines that the vehicle is not under attack, the vehicle may keep the AAC mode valid.

Further, as shown in FIG. 3, if the ACC mode is active, the ACC system may determine one or more control commands and the control command may be used for the attack detection procedure. It should be understood that even the ACC mode is valid, a driver of the vehicle may control a brake and/or a throttle of the vehicle to generate one or more control commands that can be used for the attack detection procedure.

In some embodiments, if the vehicle determines that the vehicle is under attack, an alarm may be active to warn the driver that the vehicle is under attack.

In some embodiments, a Kalman filter can be used for estimating a state of the vehicle.

FIG. 4 illustrates a Kalman filter.

Formula 1 shows vehicle dynamics.

$$[ \begin{matrix}x ( k + 1 ) \\ v ( k + 1 ) \\ a ( k + 1 ) \\ {x}^{′} ( k + 1 ) \\ {v}^{′} ( k + 1 ) \\ {a}^{′} ( k + 1 )\end{matrix} ] = [ \begin{matrix}1 & dt & 0 & 0 & 0 & 0 \\ 0 & 1 & dt & 0 & 0 & 0 \\ 0 & 0 & 1 - dt & 0 & 0 & 0 \\ 0 & 0 & 0 & 1 & dt & 0 \\ 0 & 0 & 0 & 0 & 1 & dt \\ 0 & 0 & 0 & 0 & 0 & 1\end{matrix} ] \text{} [ \text{} \begin{matrix}x ( k ) \\ v ( k ) \\ a ( k ) \\ {x}^{′} ( k ) \\ {v}^{′} ( k ) \\ {a}^{′} ( k )\end{matrix} ] + [ \begin{matrix}0 \\ 0 \\ dt \\ 0 \\ 0 \\ 0\end{matrix} ] {u}^{+} ( k ) + [ \begin{matrix}0 \\ 0 \\ - dt \\ 0 \\ 0 \\ 0\end{matrix} ] {u}^{-} ( k ) dt * [ \begin{matrix}0 \\ 0 \\ {w}_{a} ( k ) \\ 0 \\ 0 \\ {j}^{′} ( k )\end{matrix} ] \qquad ( 1 )$$

Where x is a longitudinal position of the vehicle, v is a velocity of the vehicle, a is an acceleration of the vehicle; x′ is a longitudinal position of the target vehicle, v′is a velocity of the target vehicle, a′ is an acceleration of the target vehicle; u⁺ is a throttle command of the vehicle, u⁻ is a brake control command of the vehicle; wₐ denotes modelling uncertainty, j′ denotes jerk of the vehicle, and dt denotes sampling interval. The vehicle may use the GNSS module, the ultrasonic radar, and/or the IMU to provide the following measurements:

$$[ \begin{matrix}{y}_{x} ( k ) \\ {y}_{v} ( k ) \\ {y}_{a} ( k ) \\ {y}_{{x}^{′}} ( k ) \\ {y}_{{v}^{′}} ( k )\end{matrix} ] = [ \begin{matrix}1 & 0 & 0 & 0 & 0 & 0 \\ 0 & 1 & 0 & 0 & 0 & 0 \\ 0 & 0 & 1 & 0 & 0 & 0 \\ - 1 & 0 & 0 & 1 & 0 & 0 \\ 0 & - 1 & 0 & 0 & 1 & 0\end{matrix} ] [ \begin{matrix}x ( k ) \\ v ( k ) \\ a ( k ) \\ {x}^{′} ( k ) \\ {v}^{′} ( k ) \\ {a}^{′} ( k )\end{matrix} ] + dt * [ \begin{matrix}{v}_{x} ( k ) \\ {v}_{v} ( k ) \\ {v}_{a} ( k ) \\ {v}_{{x}^{′}} ( k ) \\ {v}_{{v}^{′}} ( k )\end{matrix} ] \qquad ( 2 )$$

Formula (1) and formula (2) can be formulated as follows:

$$x ( k + 1 ) = Ax ( k ) + Bu ( k ) + w ( k ) \qquad ( 3 )$$

$$y ( k ) = Cx ( k ) + v ( k ) \qquad ( 4 )$$

Where x(k) is a system's state at a moment k, u(k) is a control data at the moment k, y(k) is an observation data at the moment k. Since dt*j′ is a value close to zero, we approximate dt*j′ as a normally distributed value with 0 mean. The zero-mean white Gaussian random variables w(k) and v(k) describe process noise and measurement noise at the moment k, respectively.

A standard Kalman filter for formula (3) and formula (4) consists of two steps: prediction and correction.

The following formula (5) shows the prediction, and the following formula (6) shows the correction:

$$x ( k \vert k - 1 ) = Ax ( k - 1 \vert k - 1 ) + Bu ( k - 1 ) \qquad ( 5 )$$

$$x ( k \vert k ) = x ( k \vert k - 1 ) + K ( [ y ( k ) - Cx ( k \vert k - 1 ) ] \qquad ( 6 )$$

Where K is a Kalman gain that can be determined through solving a discrete-time algebraic Riccati equation (DARE); and A, B, and C are system matrices that can be determined by off-line experiments.

Referring to FIG. 2, in some embodiments, the first correction data is x(k−1|k−1) in the formula (5), the first control data is u(k−1) in the formula (5), the first predication data is x(k|k−1) in the formula (5), and the first observation data is y(k) in the formula (6).

y(k)-Cx(k|k−1) in the formula (5) is referred to as “residue” or “innovation”. It is assumed that the following lemma is given:

Lemma: the innovation y(k)-Cx(k|k−1) is zero-mean white Gaussian distributed with covariance CPC′+R, where P and R are conversances of prediction error and measurement noise.

According to the above-mentioned lemma and an output of the Kalman filter, the vehicle may determine whether the malicious attack is occurred.

In some embodiments, a statistical detection algorithm may be used to determine whether the malicious attack is occurred. The statistical detection algorithm may include a Chi-squared test, a cumulative sum control chart (CUSUM) or the like.

Take the CUSUM as an example, an evaluation parameter may be determined according to the following formula:

$${E}_{k} = {\sum }_{i = k - T + 1}^{k} {{[ y ( i ) - Cx ( i \vert i - 1 ) ]}^{′} [ {CPC}^{′} + R ]}^{- 1} [ y ( i ) - Cx ( i \vert i - 1 ) ] , \qquad ( 7 )$$

Where Eₖ is the evaluation parameter, T is a window size for the CUSUM, y(i) is an observation data obtained by the at least one sensor at a moment i, and where x(i|i−1) is a prediction data of the at least one sensor at the moment i.

In some other embodiments, the evaluation parameter may be the innovation

$$y ( k ) = Cx ( k \vert k - 1 ) .$$

If the evaluation parameter is less than or equals to a preset threshold, the vehicle may determine that the vehicle is not under attack; and if the evaluation parameter is greater than the preset threshold, the vehicle may determine that the vehicle is under attack.

A value of the preset threshold may be determined according to sensitivity of the statistical detection algorithm. If the value of the preset threshold is too low, the alarm will be easily triggered which will cause a false alarm; and if the value of the preset threshold is too high, the alarm will be hardly triggered which will cause a low detection accuracy.

FIG. 5 illustrates the above-mentioned attack detection procedure.

As shown in FIG. 5, input data of the procedure include vehicle's sensor data and actuator data. The actuator data includes the at least one control command. The Kalman filter and the CUSUM are configured to determine whether the vehicle is under attack.

In some embodiments, a variation of the Kalman filter, such as an extended Kalman filter or an adaptive Kalman filter, can also be configured to be the detection procedure.

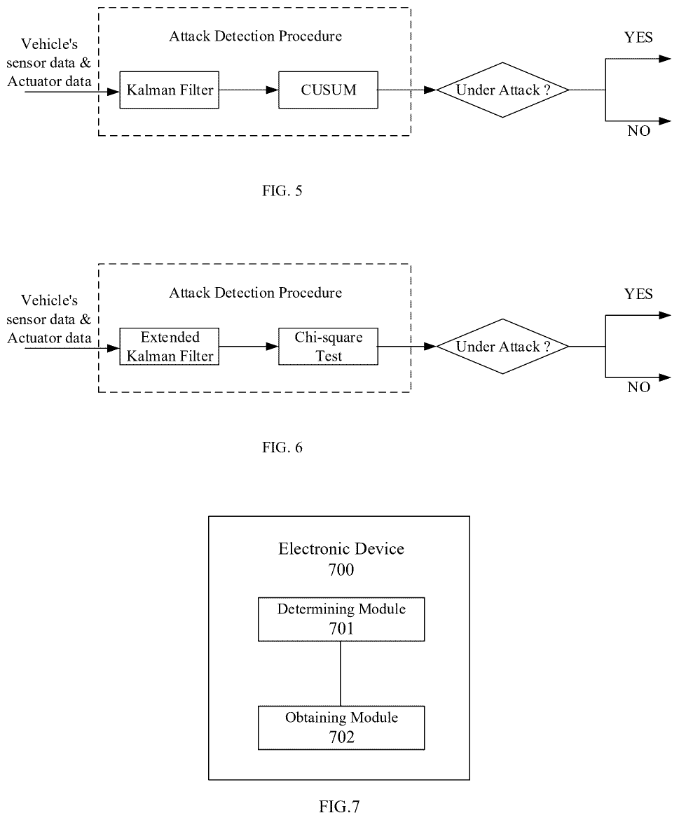

FIG. 6 illustrates another attack detection procedure provided by the embodiment of the present application.

Input data of the attack detection procedure is the same as the input data of the attack detection procedure shown in FIG. 5. Unlike the attack detection procedure shown in FIG. 5, the extended Kalman filter and the Chi-square test are used for the attack detection procedure.

Compared with the Kalman filter, the extended Kalman filter mainly solves the state estimation problem for a nonlinear system. For instance, in the real world, because of the unknown vehicle dynamics, system equations (1) and (2) are usually a linear approximation of the actual vehicle dynamics. Considering the actually vehicle dynamics, it can be better modeled as a nonlinear system with less uncertainty as follows:

$$x ( k + 1 ) = f ( x ( k ) , u ( k ) ) + w ( k ) , \qquad ( 8 )$$

$$y ( k ) = h ( x ( k ) ) + v ( k ) , \qquad ( 9 )$$

Where x(k) is a system's state at a moment k, u(k) is a control data at the moment k, y(k) is an observation data at the moment k, f(,) is a nonlinear function for describing a driving status of the vehicle; h( ) is a nonlinear function for describing a relation of sensor data and the driving status of the vehicle, f(,) and h(k) may be determined in according to the driving status of the vehicle and/or an artificial intelligence (AI) module. The zero-mean white Gaussian random variables w(k) and v(k) describe process noise and measurement noise at the moment k, respectively.

Then an extended Kalman filter can be used to better estimate the vehicle state. The extended Kalman filter also consists of two steps, i.e., prediction and correction (or referred to as update).

The prediction procedure includes the following formulas:

$$x ( k \vert k - 1 ) = f ( x ( k - 1 \vert k - 1 ) , u ( k ) ) , \qquad ( 10 )$$

$$P ( k \vert k - 1 ) = F ( k ) P ( k - 1 \vert k - 1 ) {F}^{T} ( k ) + Q ( k ) , \qquad ( 11 )$$

where f (x(k−1|k−1),u(k)) is a nonlinear function.

$${F ( k ) = \frac{\partial f}{\partial x} \vert}_{x ( k - 1 ) \vert ( k - 1 ) , u ( k )} .$$

F^{T} (k) is the transpose matrix of F(k), and Q(k) is a covariance matrix of w(k).

The correction procedure includes the following formulas:

$$y ( k ) = y ( k ) - h ( x ( k \vert k - 1 ) ) , \qquad ( 12 )$$

$$S ( k ) = H ( k ) P ( k \vert k - 1 ) {H}^{T} ( k ) + R ( k ) , \qquad ( 13 )$$

$$K ( k ) = P ( k \vert k - 1 ) {H}^{T} ( k ) {S}^{- 1} ( k ) , \qquad ( 14 )$$

$$x ( k \vert k ) = x ( k \vert k - 1 ) + K ( k ) y ( k ) , \qquad ( 15 )$$

$$P ( k \vert k ) = ( I - K ( k ) H ( k ) ) P ( k \vert k - 1 ) , \qquad ( 16 )$$

The formula (12) is a residue at time k. The formula (13) is a residue covariance. The formula (14) is a near-optimal Kalman gain. The formula (15) is an updated state estimate. The formula (16) is an updated covariance estimate.

For the above-mentioned formulas (12) to (16), h(x(k|k−1)) is the predicted sensor measurement, H(k) satisfies

$${H ( k ) - \frac{\partial h}{\partial x} \vert}_{x ( k ) \vert ( k - 1 )} ,$$

H^{T}(k) is the transpose matrix of H(k), y(k) is the residue at time k, R(k) is a covariance matrix of v(k), S⁻¹(k) is the inverse matrix of S(k), and K(k) is near-optimal Kalman filter gain.

Referring to FIG. 2, in some embodiments, the first correction data is P(k−1|k−1) in the formula (11), the first control data is u(k) in the formula (10), the first prediction data is P (k|k−1) in the formula (11), and the first observation data is y(k) in the formula (12).

Further, when the first prediction data and the first observation are determined according to the extended Kalman filter, and when the CUSUM is used for determining the evaluation parameter, the evaluation parameter may be determined according to the above-mentioned formula (7).

Besides the Kalman filter or variations of the Kalman filter, a Luenberger observer or the like can also be used to determine input data of the statistical detection. In another word, the Kalman filter shown in FIG. 4 or the adaptive Kalman filter shown in FIG. 5 may be replaced by the Luenberger observer.

Take the Luenberger observer as an example, it has the following mode:

$$x ( k ) = Ax ( k - 1 ) + L ( y ( k - 1 ) - Cx ( k - 1 ) ) + Bu ( k - 1 ) , \qquad ( 17 )$$

where A, B, and C are system matrices that can be determined by off-line experiments, L is chosen such that the matrix(A-LC) has all eigenvalues located inside the unit circle. x(k−1) is the estimate of x(k−1), u(k−1) is a control data at the moment k−1, and y(k−1) is an observation data at the moment k−1.

Referring to FIG. 2, in some embodiments, the first correction data is y(k−1)-Cx(k−1) in the formula (17), the first control data is u (k−1) in the formula (17), the first prediction data is x(k) in the formula (17), and y(k) is the first observation data.

In some embodiments, an evaluation parameter may be determined according to the following formula:

$${E}_{k} = y ( k ) - Cx ( k ) , \qquad ( 18 )$$

where Eₖ is the evaluation parameter, y(k) is the first observation, and x(k) is the first prediction data. The evaluation parameter may be used to compare with a preset threshold to determine whether the vehicle is under attack. For example, if the evaluation parameter is less than or equals to a preset threshold, the vehicle may determine that the vehicle is not under attack; and if the evaluation parameter is greater than the preset threshold, the vehicle may determine that the vehicle is under attack.

For convenience, the attack detection procedure may be divided into two steps. Input data of the first step is the vehicle's sensor data and the actuator data, and the output data of the first step is input data of the second step. Output of the second step is a result of the attack detection procedure. As above-mentioned, the first step may be implemented by the Kalman filter, the variations of the Kalman filter, the Luenberger observer, or the like, and the second step may be implemented by the statistical detection algorithm, such as the Chi-squared test, the CUSUM) or the like.

In some embodiments, artificial intelligence (AI) may be used to determine whether the vehicle is under attack. For example, a deep learning model may be trained according to training data, where the training data may include at least one of the followings: output data of the Kalman filter (variations of Kalman filter, Luenberger observer, or the like), the sensor data, or the actuator data. In some embodiments, the training data may further include label data indicating whether the vehicle is under attack. The output data of the first step may be input into the trained deep-learning model, and the deep-learning model may output the result indicating whether the vehicle is under attack.

In some embodiments, sensor fusion may be applied to process the sensor data. For example, the Kalman filter may be used for the sensor fusion. The sensor fusion can adjust the sensor data to obtain a more precise prediction result.

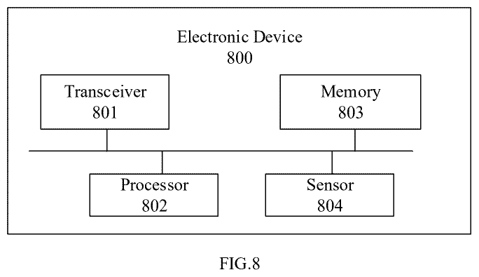

FIG. 7 is a schematic block diagram of an electronic device 700 according to an embodiment of the present application. Referring to FIG. 7, the electronic device 700 includes a determining module 701 and an obtaining module 702.

The determining module 701 is configured to determine a first prediction data according to a first correction data and a first control data, where the first correction data is a correction data of at least one sensor in the vehicle at a moment k−1, the first control data comprises at least one control command of the vehicle at the moment k−1, the first prediction data is a prediction data of the at least one sensor at a moment k, and k is a positive integer.

The obtaining module 702 is configured to obtain a first observation data by the at least one sensor at the moment k.

The determining module 702 is further configured to determine whether the vehicle is under attack according to the first observation data and the first prediction data.

In some embodiments, the first prediction data is determined based on a Kalman filter.

In some embodiments, the first predication data satisfies the following formula: x(k|k−1)=Ax(k−1|k−1)+Bu(k−1), where x(k|k−1) is the first prediction data, x(k−1|k−1) is the first correction data, u(k−1) is the first control data, and A and B are preset matrices.

In some embodiments, the determining module 701 is further configured to determine a second correction data according to the first prediction data and the first observation data based on the Kalman filter.

In some embodiments, the second correction data satisfies the following formula: x(k|k)=x(k|k−1)+K [y(k)-Cx(k|k−1)], where x(k|k) is the second correction data, x(k|k−1) is the first prediction data, y(k) is the first observation data, and K and C are preset matrices.

In some embodiments, y(k)-Cx(k|k−1) is zero-mean white Gaussian distributed with covariance CPC′+R, where P is covariance of prediction error, and R is covariance of measurement noise.

In some embodiments, the determining module 701 is specifically configured to: determine an evaluation parameter based on the observation data and the first prediction data according to the following formula:

$${E}_{k} {\sum }_{i = k - T + 1}^{k} {{[ y ( i ) - Cx ( i \vert i - 1 ) ]}^{′} [ {CPC}^{′} + R ]}^{- 1} [ y ( i ) - Cx ( i \vert i - 1 ) ] ,$$

where Eₖ is the evaluation parameter, T is a window size for detection, y(i) is an observation data obtained by the at least one sensor in moment i, and x(i|i−1) is a prediction data of the at least one sensor at a moment i, determine that the vehicle is not under attack when the evaluation parameter is less than or equals to a preset threshold; and determine that the vehicle is under attack when the evaluation parameter is greater than the preset threshold.

As shown in FIG. 8, an electronic device 800 may include a transceiver 801, a processor 802, and a memory 803. The memory 803 may be configured to store code, instructions, and the like executed by the processor 802. The electronic device 800 may be the vehicle or a component of the vehicle in the above-mentioned embodiments. If the electronic device 800 is the vehicle, the electronic device 800 may include two or more sensors 804.

It should be understood that the processor 802 may be an integrated circuit chip and has a signal processing capability. In an implementation process, steps of the foregoing method embodiments may be completed by using a hardware integrated logic circuit in the processor, or by using instructions in a form of software. The processor may be a general-purpose processor, a micro-processor unit (MPU), a digital signal processor (DSP), an application-specific integrated circuit (ASIC), a field programmable gate array(FPGA) or another programmable logic device, a discrete gate or a transistor logic device, or a discrete hardware component. The processor may implement or perform the methods, the steps, and the logical block diagrams that are disclosed in the embodiments of the present invention. The general-purpose processor may be a microprocessor, or the processor may be any conventional processor or the like. The steps of the methods disclosed with reference to the embodiments of the present invention may be directly performed and completed by a hardware decoding processor, or may be performed and completed by using a combination of hardware in the decoding processor and a software module. The software module may be located in a mature storage medium in the art, such as a random-access memory, a flash memory, a read-only memory, a programmable read-only memory, an electrically erasable programmable memory, or a register. The storage medium is located in the memory, and the processor reads information in the memory and completes the steps of the foregoing methods in combination with hardware in the processor.

It may be understood that the memory 803 in the embodiments of the present invention may be a volatile memory or a nonvolatile memory, or may include both a volatile memory and a nonvolatile memory. The nonvolatile memory may be a read-only memory(ROM), a programmable read-only memory(PROM), an erasable programmable read-only memory (EPROM), an electrically erasable programmable read-only memory(EEPROM), or a flash memory. The volatile memory may be a random-access memory(RAM) and is used as an external cache. By way of example rather than limitation, many forms of RAMs may be used, and are, for example, a static random access memory(SRAM), a dynamic random access memory(DRAM), a synchronous dynamic random access memory(SDRAM), a double data rate synchronous dynamic random access memory(DDR SDRAM), an enhanced synchronous dynamic random access memory(Enhanced SDRAM, ESDRAM), a synchronous link dynamic random access memory(SLDRAM), and a direct rambus random access memory(DR RAM).

An embodiment of the present application further provides a chip system, where the chip includes an input/output interface, at least one processor, at least one memory, and a bus. The at least one memory is configured to store instructions, and the at least one processor is configured to invoke the instructions of the at least one memory to perform operations performed by the vehicle in the methods in the foregoing embodiments.

An embodiment of the present application further provides a computer storage medium, where the computer storage medium may store a program instruction for performing the steps performed by the vehicle in the foregoing methods.

Optionally, the storage medium may be specifically the memory 803.

An embodiment of the present application further provides a computer program product, where when the computer program product runs on an electronic device, the electronic device is enabled to perform the steps performed by the vehicle in the foregoing methods.

A person of ordinary skill in the art may be aware that, in combination with the examples described in the embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present application.

It may be clearly understood by a person skilled in the art that, for the purpose of convenient and brief description, for a detailed working process of the foregoing system, apparatus, and unit, refer to a corresponding process in the foregoing method embodiment. Details are not described herein again.

In the embodiments of the present application, “at least one” means one or more, and “a plurality of” means two or more. The term “and/or” describes an association relationship between associated objects and represents that three relationships may exist. For example, A and/or B may represent the following three cases: only A exists, both A and B exist, and only B exists, where A and B may be singular or plural. The character “I” generally indicates an “or” relationship between the associated objects. “At least one of the following” and a similar expression thereof refer to any combination of these items, including any combination of one item or a plurality of items. For example, at least one of a, b, and c may indicate: a, b, c, a and b, a and c, b and c, or a, b, and c, where a, b, and c may be singular or plural.

In the several embodiments provided in the present application, it should be understood that the disclosed system, apparatus, and method may be implemented in other manners. For example, the described apparatus embodiment is merely an example. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may be or may not be physically separated, and parts displayed as units may be or may not be physical units, may be located in one position, or may be distributed on a plurality of network units. Some or all of the units may be selected based on actual requirements to achieve the objectives of the solutions of the embodiments.

In addition, functional units in the embodiments of the present application may be integrated into one processing unit, or each of the units may exist alone physically, or two or more units are integrated into one unit.

When the functions are implemented in a form of a software functional unit and sold or used as an independent product, the functions may be stored in a computer readable storage medium. Based on such an understanding, the technical solutions in the present application essentially, or the part contributing to the prior art, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of the present application. The foregoing storage medium includes: any medium that can store program code, such as a USB flash drive, a removable hard disk, a read-only memory(ROM), a random-access memory(RAM), a magnetic disk, or an optical disc.

The foregoing descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for detecting an attack for a vehicle, wherein the method comprises:
determining a first prediction data according to a first correction data and a first control data, wherein the first correction data is a correction data of at least one sensor in the vehicle at a moment k−1, the first control data comprises at least one control command of the vehicle at the moment k−1, the first prediction data is a prediction data of the at least one sensor at a moment k, and k is a positive integer;
obtaining a first observation data by the at least one sensor at the moment k; and
determining whether the vehicle is under an attack according to the first observation data and the first prediction data.

2. The method according to claim 1, wherein the first prediction data is determined based on a Kalman filter.

3. The method according to claim 2, wherein the first predication data satisfies a following formula:
$$x ( k \vert k - 1 ) = Ax ( k - 1 \vert k - 1 ) + Bu ( k - 1 ) ,$$
wherein x(k|k−1) is the first prediction data, x(k−1|k−1) is the first correction data, u(k−1) is the first control data, and A and B are preset matrices.

4. The method according to claim 2, wherein the method further comprises:
determining a second correction data according to the first prediction data and the first observation data based on the Kalman filter.

5. The method according to claim 4, wherein the second correction data satisfies a following formula:
$$x ( k \vert k ) = x ( k \vert k - 1 ) + K [ y ( k ) - Cx ( k \vert k - 1 ) ] ,$$
wherein x(k|k) is the second correction data, x(k|k−1) is the first prediction data, y(k) is the first observation data, and K and C are preset matrices.

6. The method according to claim 5, wherein y(k)-Cx(k|k−1) is zero-mean white Gaussian distributed with covariance CPC′+R, wherein Pis covariance of prediction error, and R is covariance of measurement noise.

7. The method according to claim 6, wherein the determining whether the vehicle is under attack according to the first observation data and the first prediction data comprises:
determining an evaluation parameter based on the observation data and the first prediction data according to a following formula:
$${E}_{k} {\sum }_{i = k - T + 1}^{k} {{[ y ( i ) - Cx ( i \vert i - 1 ) ]}^{′} [ {CPC}^{′} + R ]}^{- 1} [ y ( i ) - Cx ( i \vert i - 1 ) ] ,$$
wherein Eₖ is the evaluation parameter, T is a window size for detection, y(i) is an observation data obtained by the at least one sensor in moment i, and x(i|i-1) is a prediction data of the at least one sensor at a moment i;
determining that the vehicle is not under attack when the evaluation parameter is less than or equals to a preset threshold; and
determining that the vehicle is under attack when the evaluation parameter is greater than the preset threshold.

8. An electronic device, wherein the electronic device comprises one or more memories configured to store programming instructions; and
one or more processors coupled to the one or more memories and configured to execute the instructions to cause the apparatus to:
determine a first prediction data according to a first correction data and a first control data, wherein the first correction data is a correction data of at least one sensor in the vehicle at a moment k−1, the first control data comprises at least one control command of the vehicle at the moment k−1, the first prediction data is a prediction data of the at least one sensor at a moment k, and k is a positive integer;
obtain a first observation data by the at least one sensor at the moment k; and
determine whether the vehicle is under an attack according to the first observation data and the first prediction data.

9. The electronic device according to claim 8, wherein the first prediction data is determined based on a Kalman filter.

10. The electronic device according to claim 8, wherein the first predication data satisfies a following formula:
$$x ( k \vert k - 1 ) = Ax ( k - 1 \vert k - 1 ) + Bu ( k - 1 ) ,$$
wherein x(k|k−1) is the first prediction data, x(k−1|k−1) is the first correction data, u(k−1) is the first control data, and A and B are preset matrices.

11. The electronic device according to claim 9, wherein the one or more processors are further configured to determine a second correction data according to the first prediction data and the first observation data based on the Kalman filter.

12. The electronic device according to claim 11, wherein the second correction data satisfies a following formula:
$$x ( k \vert k ) = x ( k \vert k - 1 ) + K [ y ( k ) - Cx ( k \vert k - 1 ) ] ,$$
wherein x(k|k) is the second correction data, x(k|k−1) is the first prediction data, y(k) is the first observation data, and K and C are preset matrices.

13. The electronic device according to claim 12, wherein y(k)-Cx(k|k−1) is zero-mean white Gaussian distributed with covariance CPC′+R, Pis covariance of prediction error, and R is covariance of measurement noise.

14. The electronic device according to claim 13, wherein the one or more processors are further configured to:
determine an evaluation parameter based on the observation data and the first prediction data according to a following formula:
$${E}_{k} {\sum }_{i = k - T + 1}^{k} {{[ y ( i ) - Cx ( i \vert i - 1 ) ]}^{′} [ {CPC}^{′} + R ]}^{- 1} [ y ( i ) - Cx ( i \vert i - 1 ) ] ,$$
wherein Eₖ is the evaluation parameter, T is a window size for detection, y(i) is an observation data obtained by the at least one sensor in moment i, and x(i|i-1) is a prediction data of the at least one sensor at a moment i;
determine that the vehicle is not under attack when the evaluation parameter is less than or equals to a preset threshold; and
determine that the vehicle is under attack when the evaluation parameter is greater than the preset threshold.

15. A vehicle, comprising an electronic device, wherein the electronic device comprises one or more memories configured to store programming instructions; and
one or more processors coupled to the one or more memories and configured to execute the instructions to cause the apparatus to:
determine a first prediction data according to a first correction data and a first control data, wherein the first correction data is a correction data of at least one sensor in the vehicle at a moment k−1, the first control data comprises at least one control command of the vehicle at the moment k−1, the first prediction data is a prediction data of the at least one sensor at a moment k, and k is a positive integer;
obtain a first observation data by the at least one sensor at the moment k; and
determine whether the vehicle is under an attack according to the first observation data and the first prediction data.
